(19) United States
(12) Patent Application Publication
(10) Pub. No.: US 2026/0342012 A1
(43) Pub. Date: Oct. 29, 2026

(54) Connector Assembly and Board End Connector Thereof

(71) Applicants: Tarng Yu Enterprise Co., Ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/660,292

(22) Filed: Apr. 28, 2026

(30) Foreign Application Priority Data
Apr. 28, 2025 (TW) 114116029

(51) Int. Cl. H01R 13/633; H01R 12/71; H01R 12/77; H01R 12/79

(52) U.S. Cl. CPC H01R 13/6335; H01R 12/716; H01R 12/777; H01R 12/79

(57) ABSTRACT

A connector assembly comprises a board end connector and a cable end connector, wherein the cable end connector is able to engage the board end connector. The board end connector and the cable end connector respectively comprise a lock structure of corresponding configuration, the lock structure is configured to lock, so as to enable the connector assembly of reduced dimensions to effectively maintain the engaging relationship between the cable end connector and the board end connector.

### CROSS-REFERENCE TO RELATED APPLICATIONS

This application claims the priority of Republic of China Patent Application No. 114116029 filed on Apr. 28, 2025, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to a connector assembly and a board end connector thereof capable of being used in electronic products with a slim design.

### Descriptions of the Related Art

Conventionally, an electronic product is usually provided with a connector assembly. The connector assembly comprises a cable end connector and a board end connector. The cable end connector is configured to engage the board end connector to provide transmission of electrical signals. In an implementation state of the connector assembly on the electronic product, the cable end connector contacts the board end connector to maintain an engaging relationship between the cable end connector and the board end connector by frictional force. However, in recent years, electronic products have a development trend toward thin and light designs, resulting in limited internal space of the electronic products, which causes the size of the connector assembly to be required to be reduced. As such, a contact area between the cable end connector and the board end connector is decreased, such that sufficient frictional force cannot be provided to maintain the engaging relationship between the cable end connector and the board end connector.

Based on the foregoing, how to improve a structural design of the connector assembly, so that the connector assembly with a reduced size can effectively maintain the engaging relationship between the cable end connector and the board end connector, is an urgent issue of concern for those skilled in the technical field.

### SUMMARY OF THE INVENTION

In view of the drawbacks of the prior art mentioned above, the present application provides a board end connector configured to mate with a circuit board, the board end connector comprising:a board end insulation body, wherein one side of the board end insulation body is a board end body positioning major side, an interior of the board end insulation body comprises a board end insulation body major side lock space, the board end insulation body major side lock space is disposed at the board end body positioning major side; and a board end major side positioning member, the board end major side positioning member comprises a board end major side positioning member lock structure and a board end major side positioning member insertion structure, wherein the board end major side positioning member mates with the board end insulation body at the board end body positioning major side, such that the board end major side positioning member lock structure is disposed in the board end insulation body major side lock space; and the board end major side positioning member insertion structure is configured to provide insertion connection with the circuit board at the board end body positioning major side, so as to position the board end connector by way of the circuit board.

Preferably, the board end connector said above, wherein the board end connector further comprises: a board end conductive terminal and a board end terminal limiting member, the board end conductive terminal enters the board end insulation body, the board end terminal limiting member enters the board end insulation body and plug-connects or abuts the board end conductive terminal, so as to limit the board end conductive terminal by way of the board end insulation body.

Preferably, the board end connector said above, wherein another side of the board end insulation body is a board end body positioning minor side, the interior of the board end insulation body further comprises a board end insulation body minor side lock space, the board end insulation body minor side lock space is disposed at the board end body positioning minor side; and the board end connector further comprises: a board end minor side positioning member, the board end minor side positioning member comprises a board end minor side positioning member lock structure and a board end minor side positioning member insertion structure,wherein the board end minor side positioning member mates with the board end insulation body at the board end body positioning minor side, such that the board end minor side positioning member lock structure is disposed in the board end insulation body minor side lock space; and the board end minor side positioning member insertion structure is configured to provide insertion connection with the circuit board at the board end body positioning minor side, so as to position the board end connector by way of the circuit board.

Preferably, the board end connector said above, wherein the board end major side positioning member lock structure is a hole-shaped structure; and the board end minor side positioning member lock structure is a hole-shaped structure.

Preferably, the board end connector said above, wherein the board end major side positioning member and the board end minor side positioning member are metal members.

Additionally, the present application provides a connector assembly comprising:a board end connector comprising: a board end insulation body, wherein one side of the board end insulation body is a board end body positioning major side, an interior of the board end insulation body comprises a board end insulation body major side lock space, the board end insulation body major side lock space is disposed at the board end body positioning major side; a board end major side positioning member comprising a board end major side positioning member lock structure, wherein the board end major side positioning member mates with the board end insulation body at the board end body positioning major side, such that the board end major side positioning member lock structure is disposed in the board end insulation body major side lock space; a cable end connector configured to engage the board end connector, the cable end connector comprises: a cable end insulation body, wherein one side of the cable end insulation body is a cable end body positioning major side; and a cable end major side positioning member comprising a cable end major side positioning member lock structure; wherein the cable end major side positioning member mates with the cable end insulation body, such that the cable end major side positioning member lock structure is disposed at the cable end body positioning major side; wherein, during a process in which the cable end connector engages the board end connector, the cable end major side positioning member lock structure is configured to enter the board end insulation body major side lock space and lock with the board end major side positioning member lock structure, so as to position the cable end connector by way of the board end connector.

Preferably, the connector assembly said above, wherein the cable end connector further comprises: a cable end conductive terminal; and the board end connector further comprises: a board end conductive terminal comprising a board end terminal engaging structure and a board end terminal front end insulator, the board end terminal front end insulator is disposed at a front end of the board end terminal engaging structure, so that during a process in which the cable end connector engages the board end connector, the cable end conductive terminal sequentially abuts the board end terminal front end insulator and the board end terminal engaging structure.

Preferably, the connector assembly said above, wherein another side of the board end insulation body is a board end body positioning minor side, the interior of the board end insulation body further comprises a board end insulation body minor side lock space disposed at the board end body positioning minor side; the board end connector further comprises: a board end minor side positioning member further comprising a board end minor side positioning member lock structure, wherein the board end minor side positioning member mates with the board end insulation body at the board end body positioning minor side, such that the board end minor side positioning member lock structure is disposed in the board end insulation body minor side lock space; another side of the cable end insulation body is a cable end body positioning minor side; and the cable end connector further comprises: a cable end minor side positioning member comprising a cable end minor side positioning member lock structure; wherein the cable end minor side positioning member mates with the cable end insulation body, such that the cable end minor side positioning member lock structure is disposed at the cable end body positioning minor side; wherein during a process in which the cable end connector engages the board end connector, the cable end minor side positioning member lock structure is configured to enter the board end insulation body minor side lock space and lock with the board end minor side positioning member lock structure, so as to position the cable end connector by way of the board end connector.

Compared to the prior art, the present application proposes at least one connector assembly, and the connector assembly can be applied to an electronic product, the connector assembly comprises a board end connector and a cable end connector, wherein the cable end connector is configured to engage the board end connector to provide transmission of electrical signals in the electronic product. The board end connector and the cable end connector respectively comprise structurally corresponding lock structures, and the lock structures are configured for providing locking, so as to allow the connector assembly with a reduced size to effectively maintain an engaging relationship between the cable end connector and the board end connector. Thus, the connector assembly can be used in electronic products with limited internal space, thereby allowing the connector assembly to be used in electronic products with a slim design.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of a first perspective of the connector assembly of the present application in an embodiment.

FIG. 2 is a perspective schematic view of a second perspective of the connector assembly of the present application in an embodiment.

FIG. 3 is a perspective schematic view of a first perspective of the connector assembly of the present application in an embodiment.

FIG. 4 is a perspective schematic view of a second perspective of the connector assembly of the present application in an embodiment.

FIG. 5 is a perspective schematic view of a first perspective of the board end connector of the present application in an embodiment.

FIG. 6 is a perspective schematic view of a second perspective of the board end connector of the present application in an embodiment.

FIG. 7 is a front schematic view of the board end connector of the present application in an embodiment.

FIG. 8 is a cross-sectional schematic view of partial members of the board end connector shown in FIG. 7, taken along line AA.

FIG. 9 is a bottom schematic view of the board end connector of the present application in an embodiment.

FIG. 10 is a cross-sectional schematic view of partial members of the board end connector shown in FIG. 9, taken along line BB.

FIG. 11 is a rear schematic view of the board end connector of the present application in an embodiment.

FIG. 12 is a cross-sectional schematic view of partial members of the board end connector shown in FIG. 11, taken along line CC.

FIG. 13 is a perspective schematic view of a first perspective of the cable end connector of the present application in an embodiment.

FIG. 14 is a perspective schematic view of a second perspective of the cable end connector of the present application in an embodiment.

FIG. 15 is a perspective schematic view of a third perspective of the cable end connector of the present application in an embodiment.

FIG. 16 is a front schematic view of the cable end connector of the present application in an embodiment.

FIG. 17 is a cross-sectional schematic view of partial members of the cable end connector shown in FIG. 16, taken along line DD.

FIG. 18 is a bottom schematic view of the cable end connector of the present application in an embodiment.

FIG. 19 is a cross-sectional schematic view of partial members of the cable end connector shown in FIG. 18, taken along line EE.

FIG. 20 is a cross-sectional schematic view of partial members of the cable end connector shown in FIG. 18, taken along line FF.

FIG. 21 is a bottom schematic view of the connector assembly of the present application in an embodiment.

FIG. 22 is a cross-sectional schematic view of the connector assembly of the present application in an embodiment.

FIG. 23 is a bottom schematic view of the connector assembly of the present application in an embodiment.

FIG. 24 is a cross-sectional schematic view of the connector assembly of the present application in an embodiment.

FIG. 25 is a cross-sectional schematic view of the connector assembly of the present application in an embodiment.

FIG. 26 is a perspective schematic view of partial members of the connector assembly of the present application in an embodiment.

FIG. 27 is a perspective schematic view of the connector assembly of the present application in an embodiment.

FIG. 28 is a perspective schematic view of partial members of the connector assembly of the present application in an embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Additionally, it should be noted that in order to make the disclosed content more concise and easier to understand, elements with the same or similar functions in the following embodiments will be described using the same reference numerals, and descriptions of the same or equivalent features will be omitted.

The present application provides at least one connector assembly, and the connector assembly comprises a board end connector and a cable end connector, wherein the cable end connector is configured to engage the board end connector. The board end connector and the cable end connector respectively comprise structurally corresponding lock structures, and the lock structures are configured for providing locking, so as to allow the connector assembly with a reduced size to effectively maintain an engaging relationship between the cable end connector and the board end connector.

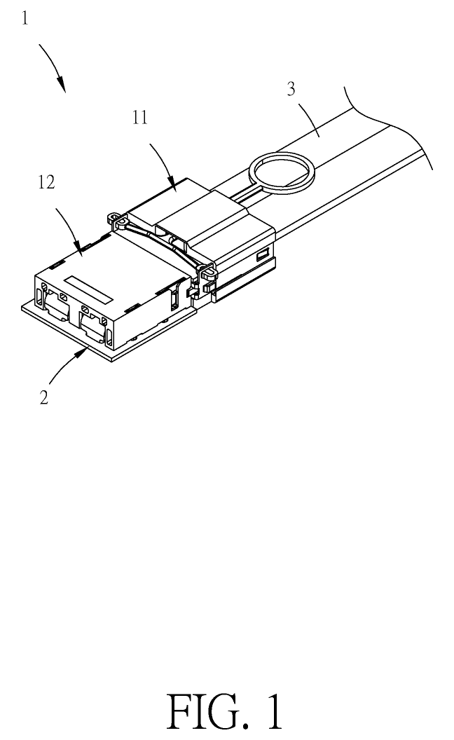

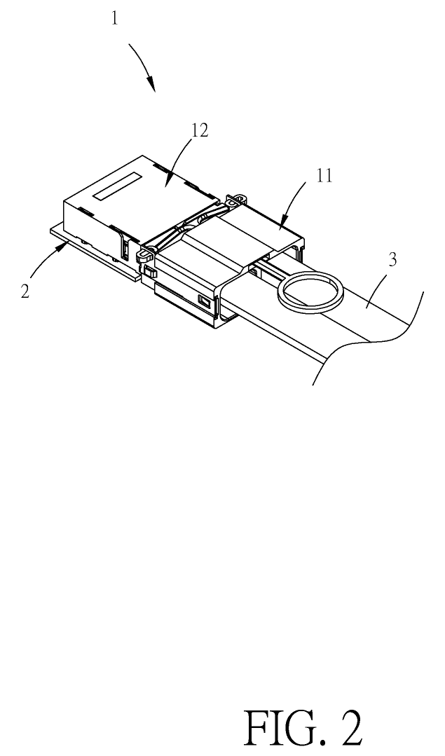

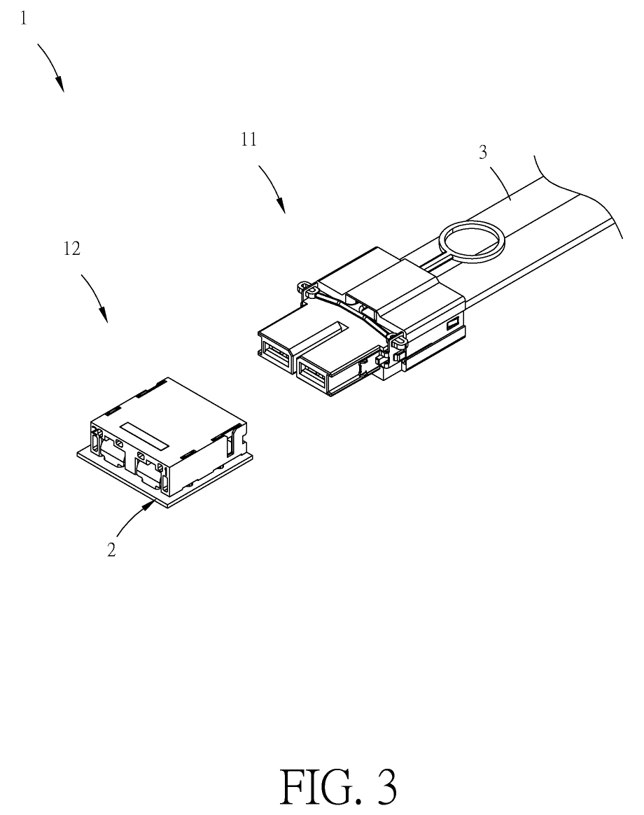

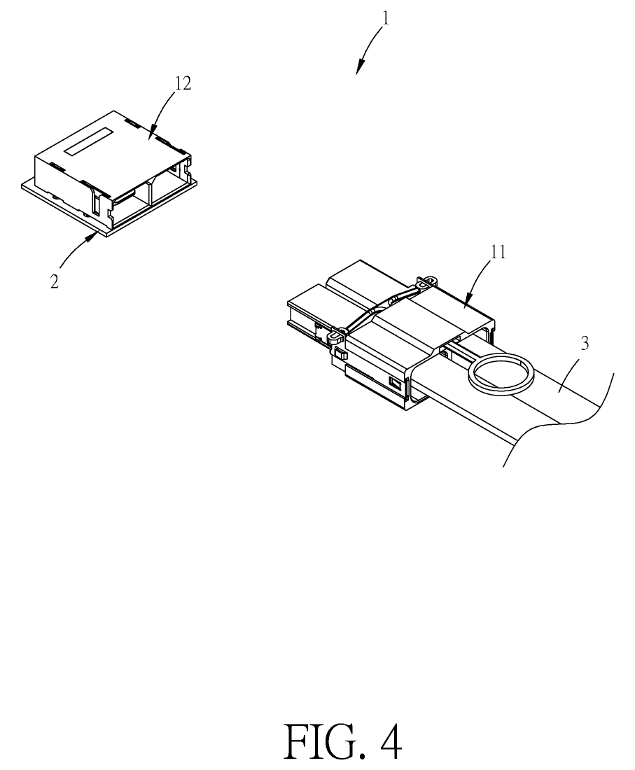

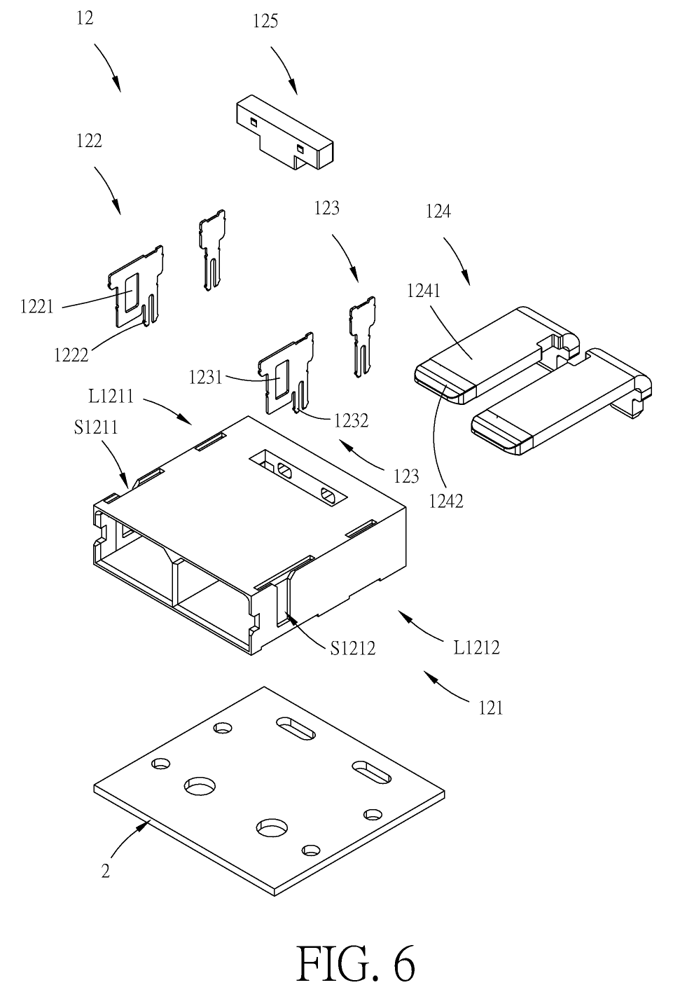

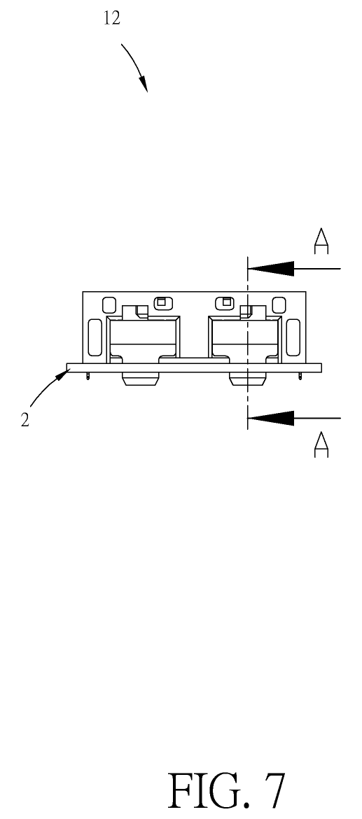

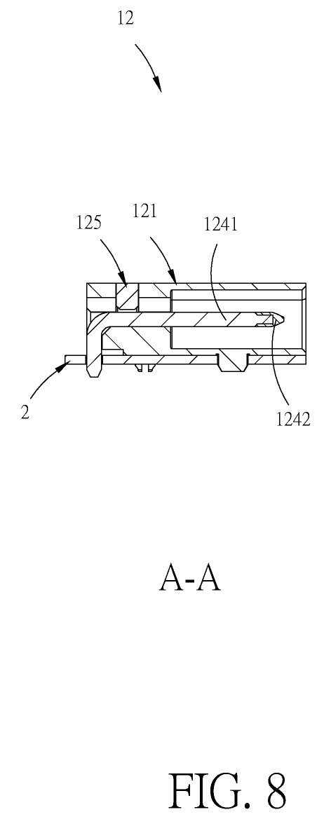

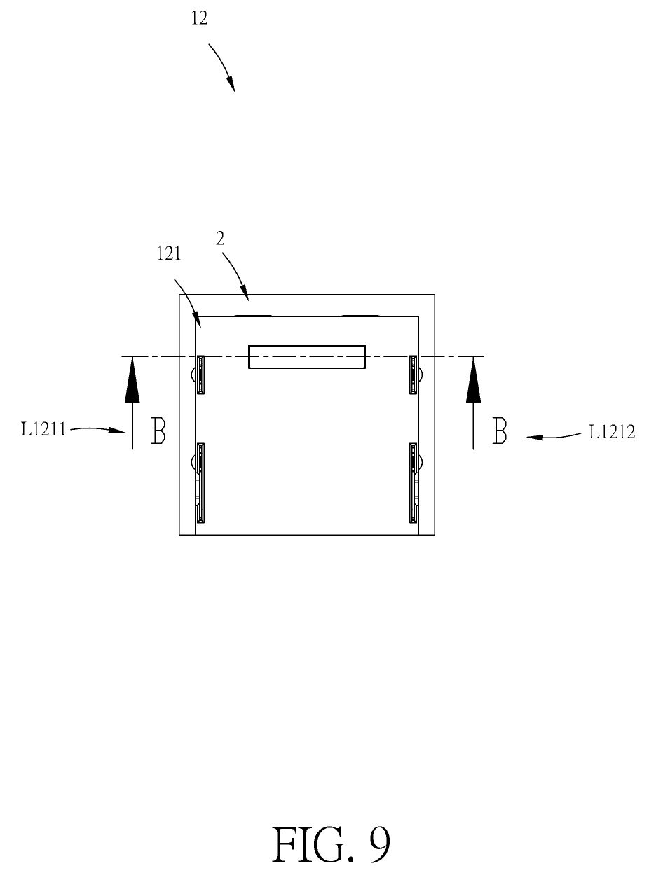

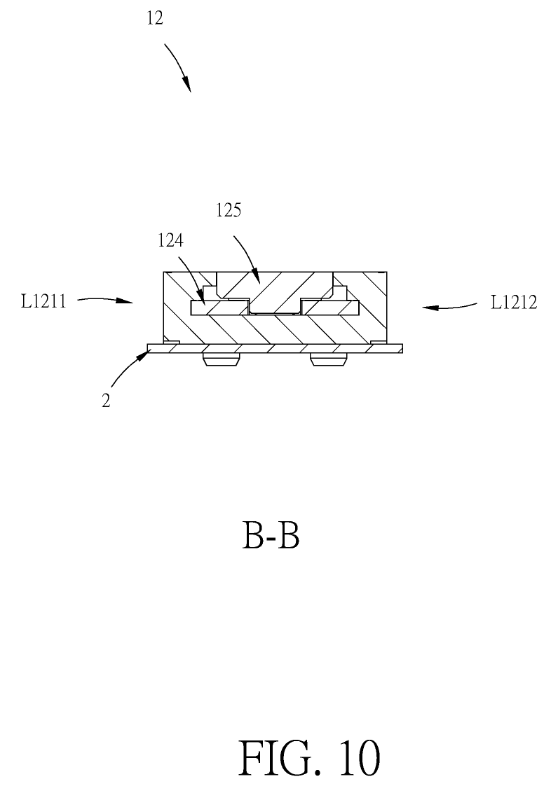

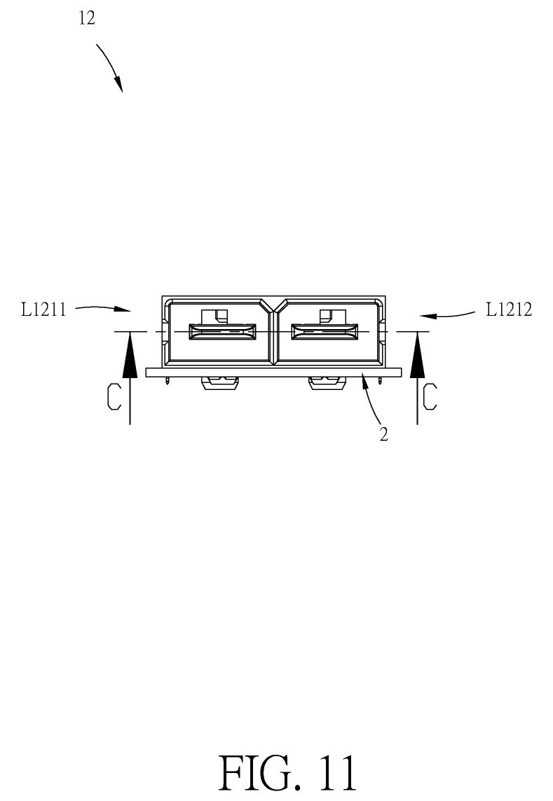

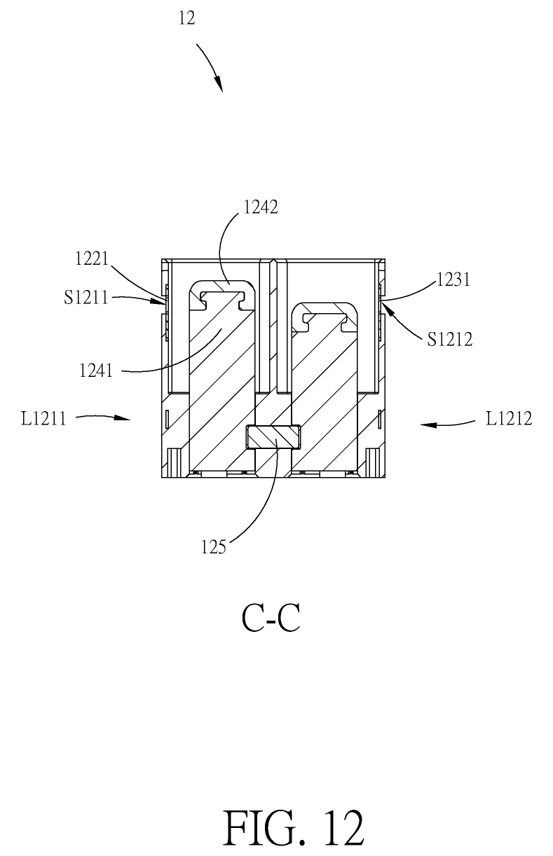

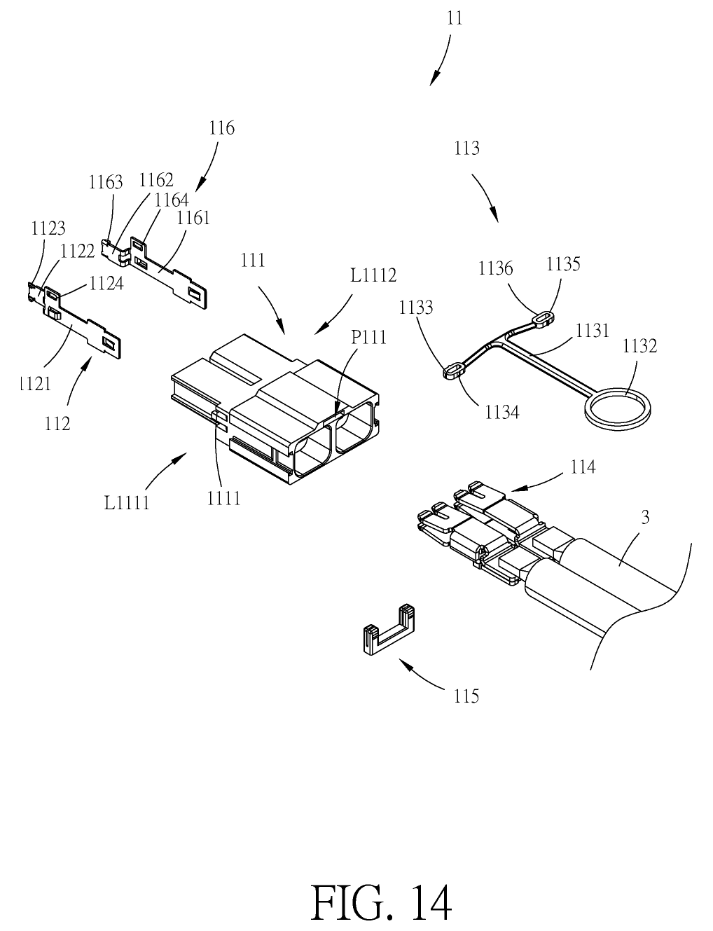

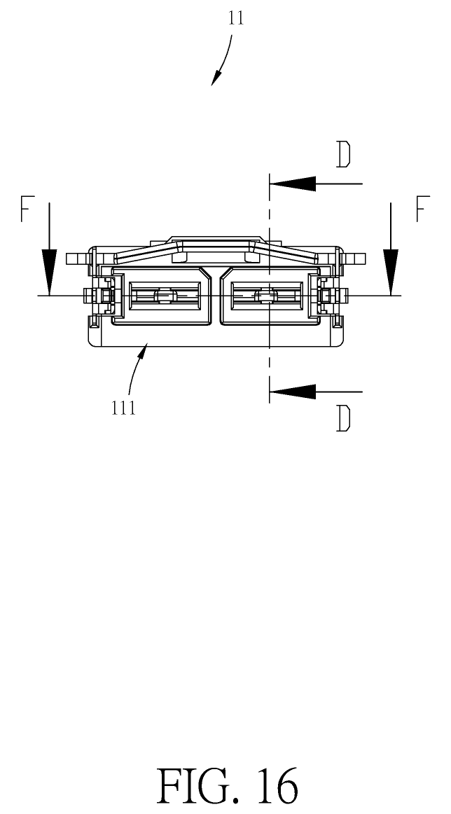

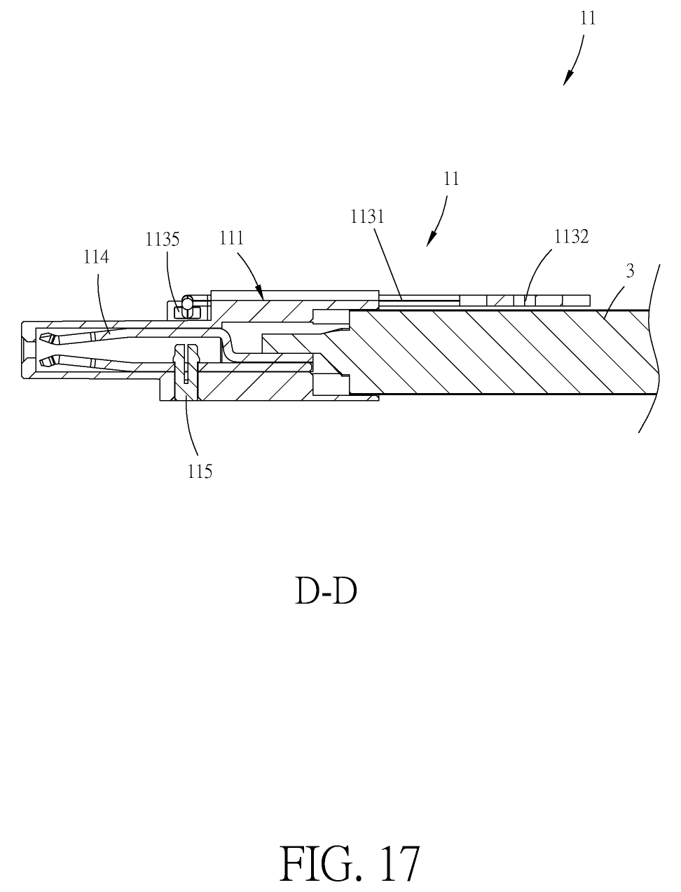

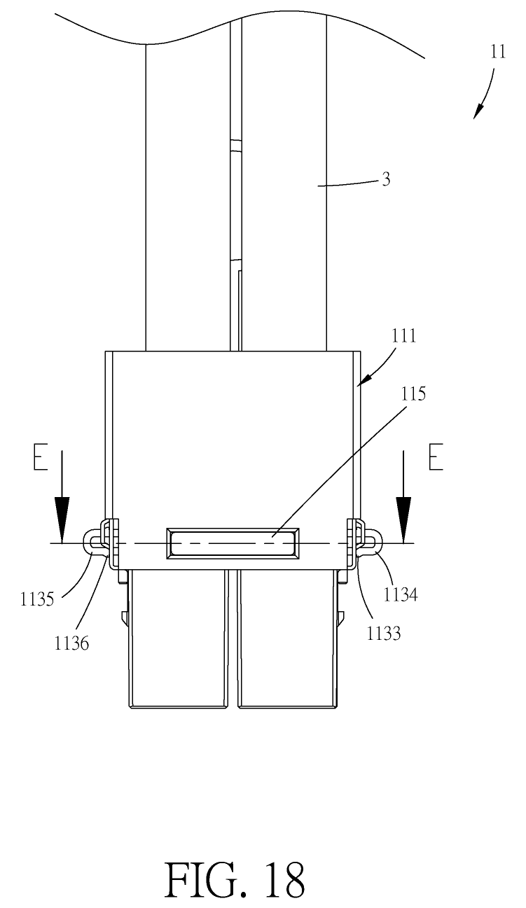

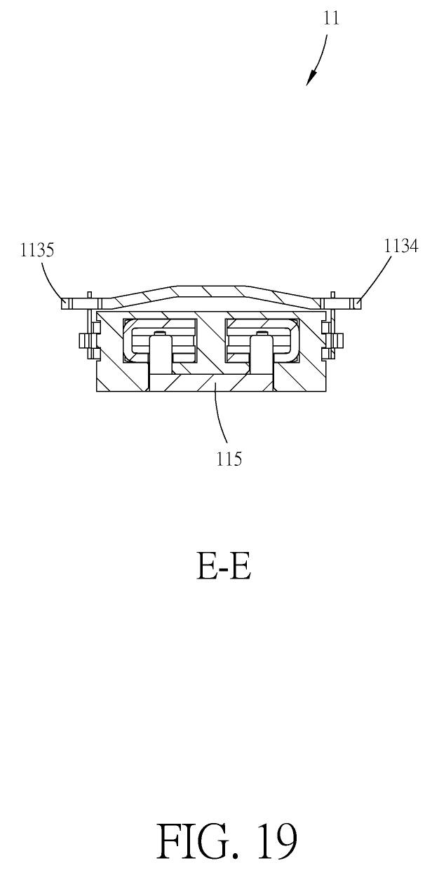

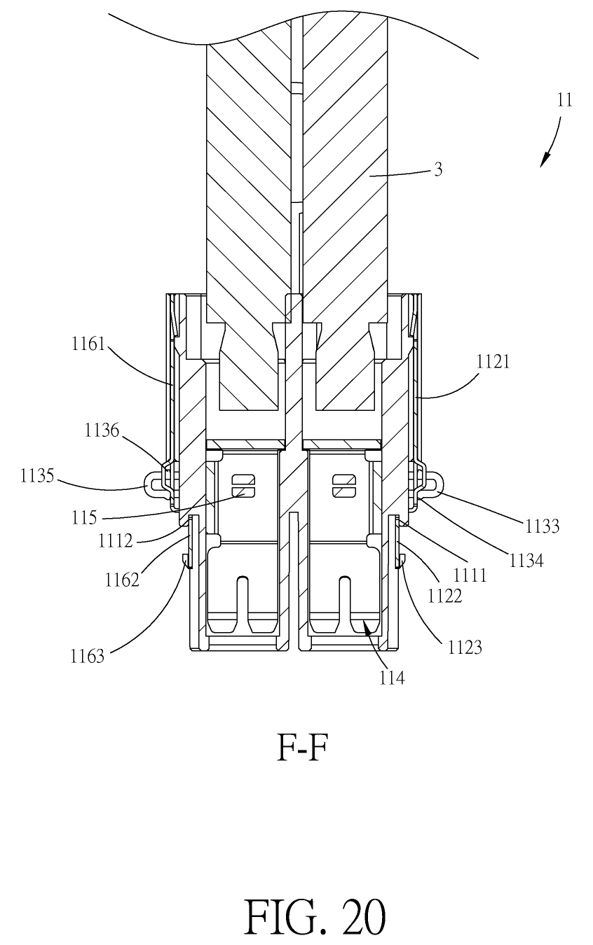

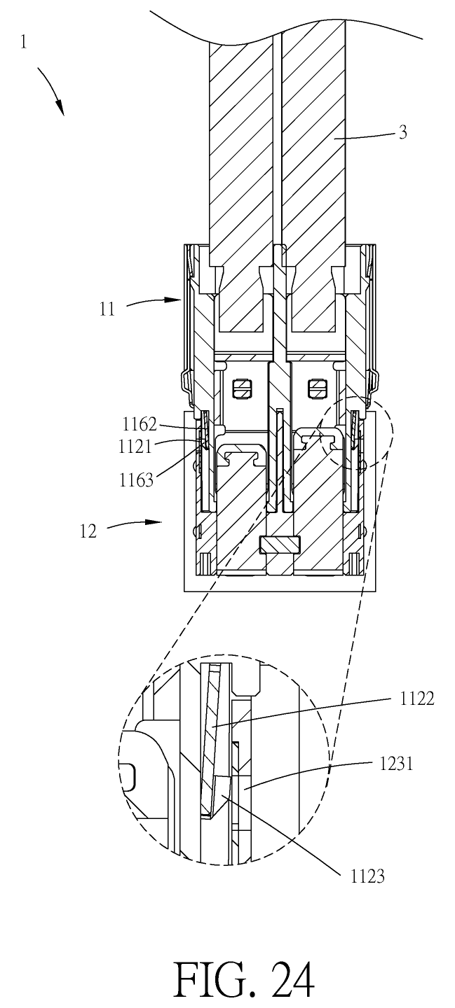

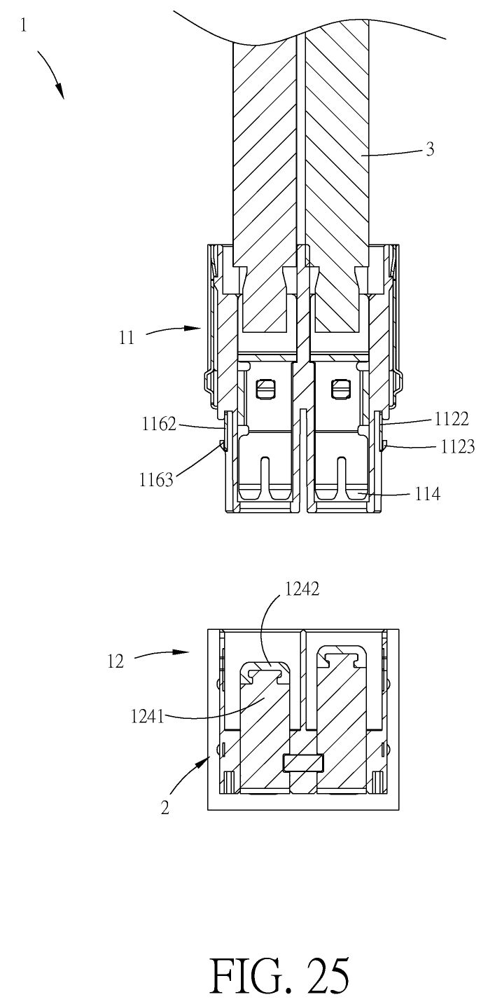

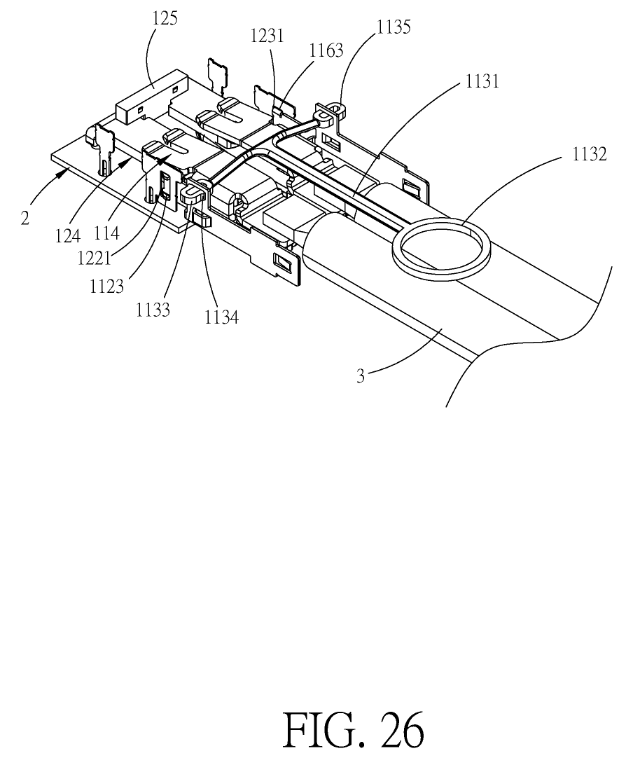

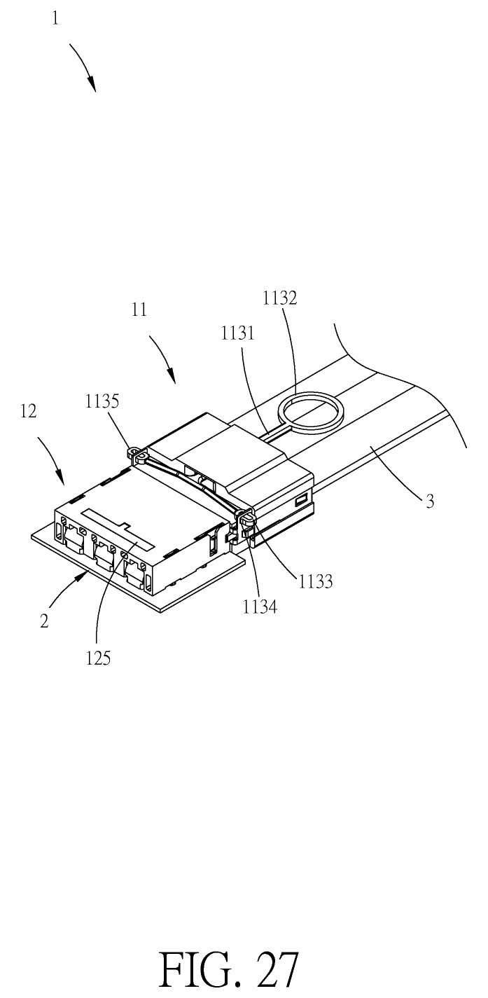

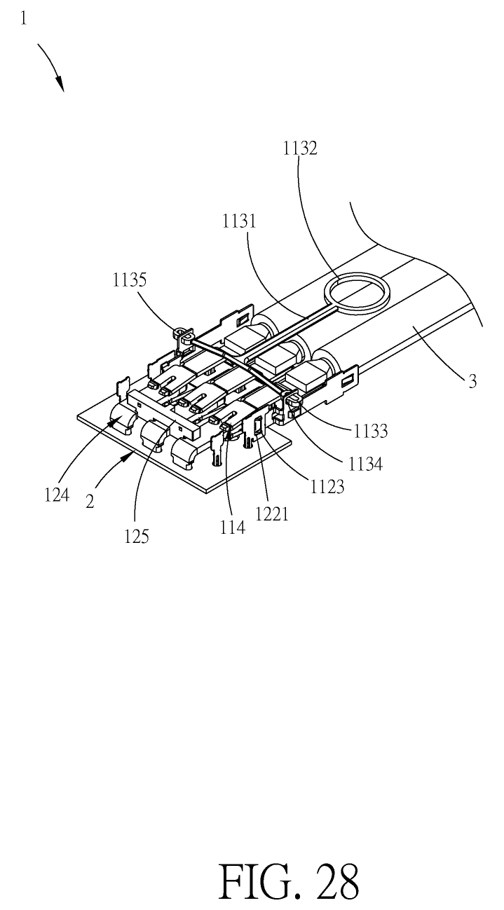

For the description of the embodiments disclosed by the technology of the present application, please refer to FIGS. 1-28 together. In the embodiments shown in FIGS. 1-28, the present application provides at least one connector assembly 1, and the connector assembly 1 comprises: a board end connector 12 and a cable end connector 11.

Regarding the board end connector 12, the board end connector 12 is configured to be used with a circuit board 2 to transmit electrical signals, and the board end connector 12 comprises: a board end insulation body 121, a board end major side positioning member 122, and a board end minor side positioning member 123. Two sides of the board end insulation body 121 are a board end body positioning major side L1211 and a board end body positioning minor side L1212 respectively, and an interior of the board end insulation body 121 comprises a board end insulation body major side lock space S1211 and a board end insulation body minor side lock space S1212, wherein the board end insulation body major side lock space S1211 is disposed at the board end body positioning major side L1211, and the board end insulation body minor side lock space S1212 is disposed at the board end body positioning minor side L1212.

The board end major side positioning member 122 is optionally a metal member, so that the strength and elasticity of the board end major side positioning member 122 meet expectations for providing positioning, and the board end major side positioning member 122 comprises a board end major side positioning member lock structure 1221 and a board end major side positioning member insertion structure 1222, wherein the board end major side positioning member 122 engages the board end insulation body 121 at the board end body positioning major side L1211, so that the board end major side positioning member lock structure 1221 is disposed in the board end insulation body major side lock space S1211, and the board end major side positioning member insertion structure 1222 is configured for providing insertion of the circuit board 2 at the board end body positioning major side L1211, so as to position the board end connector 12 by the circuit board 2. It should be noted that, in the above embodiment, the board end major side positioning member lock structure 1221 is a hole structure.

In addition, the board end minor side positioning member 123 is optionally a metal member, so that the strength and elasticity of the board end minor side positioning member 123 meet expectations for providing positioning, and the board end minor side positioning member 123 comprises a board end minor side positioning member lock structure 1231 and a board end minor side positioning member insertion structure 1232, wherein the board end minor side positioning member 123 engages the board end insulation body 121 at the board end body positioning minor side L1212, so that the board end minor side positioning member lock structure 1231 is disposed in the board end insulation body minor side lock space S1212, and the board end minor side positioning member insertion structure 1232 is configured for providing insertion of the circuit board 2 at the board end body positioning minor side L1212, so as to position the board end connector 12 by the circuit board 2. It should be noted that, in the above embodiment, the board end minor side positioning member lock structure 1231 is a hole structure.

Regarding the cable end connector 11, the cable end connector 11 is configured to be used with a conductive cable 3 to transmit electrical signals, and the cable end connector 11 is configured to engage the board end connector 12, and the cable end connector 11 comprises: a cable end insulation body 111, a cable end major side positioning member 112, a cable end minor side positioning member 116, and a cable end pull-tab member 113. Two sides of the cable end insulation body 111 are a cable end body positioning major side L1111 and a cable end body positioning minor side L1112 respectively, and the cable end insulation body 111 comprises a cable end pull-tab member threading passage P111.

The cable end major side positioning member 112 is optionally a metal member, so that the strength and elasticity of the cable end major side positioning member 112 meet expectations for providing positioning, and the cable end major side positioning member 112 comprises a cable end major side positioning member coupling segment 1121, a cable end major side positioning member cantilever segment 1122, a cable end major side positioning member lock structure 1123, and a cable end major side positioning member combination structure 1124; wherein the cable end major side positioning member lock structure 1123 and the cable end major side positioning member combination structure 1124 are disposed at the cable end major side positioning member cantilever segment 1122, and the cable end major side positioning member coupling segment 1121 of the cable end major side positioning member 112 engages the cable end insulation body 111, so that the cable end major side positioning member lock structure 1123 of the cable end major side positioning member 112 is disposed at the cable end body positioning major side L1111, and the cable end major side positioning member cantilever segment 1122 is in a cantilever state. It should be noted that, in the above embodiment, the cable end major side positioning member lock structure 1123 is a hook structure.

The cable end pull-tab member 113 comprises a cable end pull-tab member body 1131, a cable end pull-tab member force-applying structure 1132, and a cable end pull-tab member major side combination structure 1133, and the cable end pull-tab member body 1131 is respectively connected to the cable end pull-tab member force-applying structure 1132 and the cable end pull-tab member major side combination structure 1133, and the cable end pull-tab member major side combination structure 1133 of the cable end pull-tab member 113 is configured to be combined with the cable end major side positioning member combination structure 1124 of the cable end major side positioning member 112.

The cable end minor side positioning member 116 is optionally a metal member, so that the strength and elasticity of the cable end minor side positioning member 116 meet expectations for providing positioning, and the cable end minor side positioning member 116 comprises a cable end minor side positioning member coupling segment 1161, a cable end minor side positioning member cantilever segment 1162, a cable end minor side positioning member lock structure 1163, and a cable end minor side positioning member combination structure 1164; wherein the cable end minor side positioning member lock structure 1163 and the cable end minor side positioning member combination structure 1164 are disposed at the cable end minor side positioning member cantilever segment 1162, and the cable end minor side positioning member coupling segment 1161 of the cable end minor side positioning member 116 engages the cable end insulation body 111, so that the cable end minor side positioning member lock structure 1163 of the cable end minor side positioning member 116 is disposed at the cable end body positioning minor side L1112, and the cable end minor side positioning member cantilever segment 1162 is in a cantilever state. It should be noted that, in the above embodiment, the cable end minor side positioning member lock structure 1163 is a hook structure.

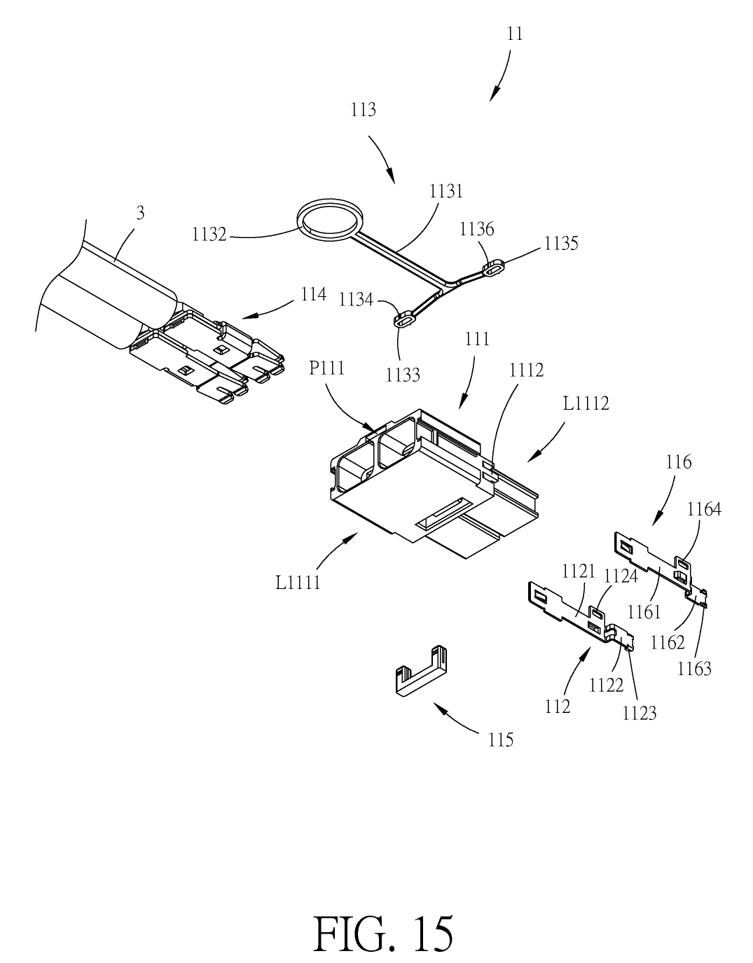

The cable end pull-tab member 113 further comprises a cable end pull-tab member minor side combination structure 1135, and the cable end pull-tab member body 1131 is further respectively connected to the cable end pull-tab member force-applying structure 1132 and the cable end pull-tab member minor side combination structure 1135, and the cable end pull-tab member minor side combination structure 1135 of the cable end pull-tab member 113 is configured to be combined with the cable end minor side positioning member combination structure 1164 of the cable end minor side positioning member 116. In the embodiment shown in FIG. 15, the cable end pull-tab member threading passage P111 is configured for providing threading of the cable end pull-tab member 113, so that the cable end pull-tab member body 1131 can pass through the cable end insulation body 111.

In the embodiment shown in FIG. 15, the cable end pull-tab member 113 comprises the cable end pull-tab member body 1131, the cable end pull-tab member force-applying structure 1132, the cable end pull-tab member major side combination structure 1133, and the cable end pull-tab member minor side combination structure 1135 so as to form a Y-shaped member.

In the embodiment shown in FIG. 15, the cable end pull-tab member major side combination structure 1133 and the cable end pull-tab member minor side combination structure 1135 are O-shaped elastic rings, so that the cable end pull-tab member major side combination structure 1133 can be elastically deformed to enter the cable end major side positioning member combination structure 1124 to complete the combination of the cable end pull-tab member minor side combination structure 1135 with the cable end minor side positioning member combination structure 1164, and the cable end pull-tab member minor side combination structure 1135 can be elastically deformed to enter the cable end minor side positioning member combination structure 1164 to complete the combination of the cable end pull-tab member major side combination structure 1133 with the cable end major side positioning member combination structure 1124. Therefore, the cable end pull-tab member is optionally made of an elastic material.

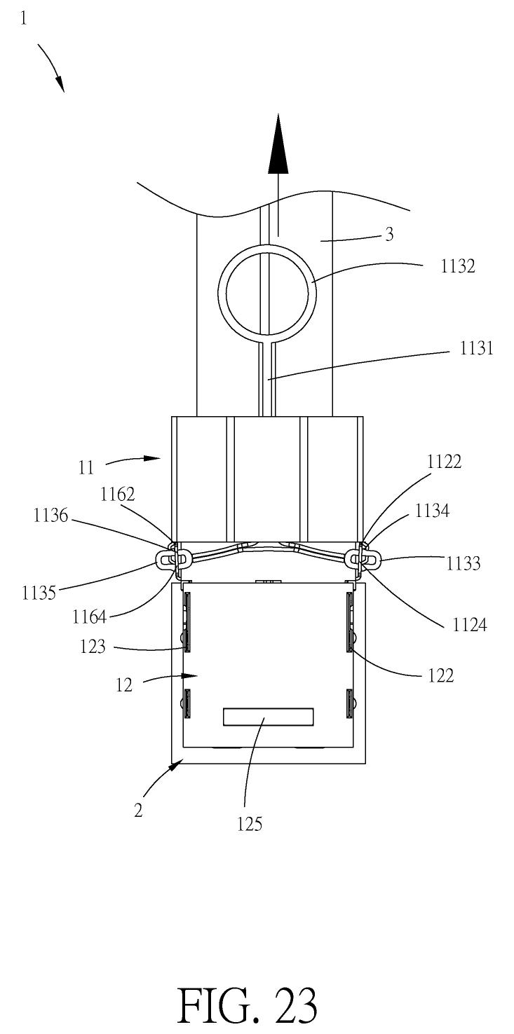

In the embodiment shown in FIG. 23, the cable end pull-tab member 113 further comprises a cable end pull-tab member major side stop structure 1134, wherein when the cable end pull-tab member major side combination structure 1133 is combined with the cable end major side positioning member combination structure 1124, the cable end pull-tab member major side stop structure 1134 abuts against the cable end major side positioning member cantilever segment 1122 to stop the cable end pull-tab member major side combination structure 1133 from leaving the cable end major side positioning member combination structure 1124.

In addition, the cable end pull-tab member 113 further comprises a cable end pull-tab member minor side stop structure 1136, wherein when the cable end pull-tab member minor side combination structure 1135 is combined with the cable end minor side positioning member combination structure 1164, the cable end pull-tab member minor side stop structure 1136 abuts against the cable end minor side positioning member cantilever segment 1162 to stop the cable end pull-tab member minor side combination structure 1135 from leaving the cable end minor side positioning member combination structure 1164.

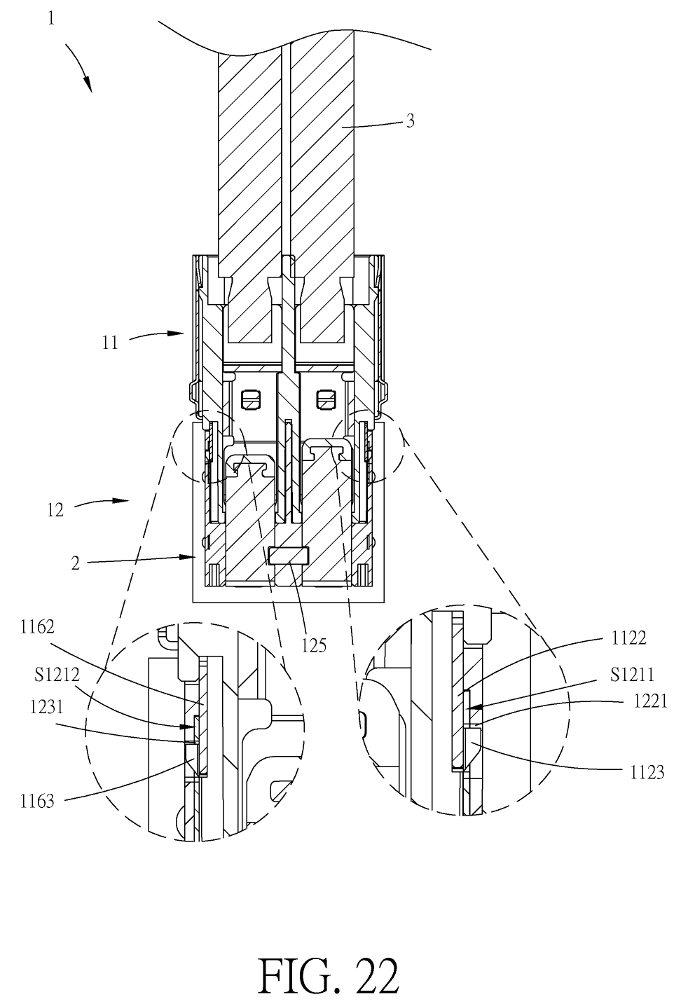

It should be noted that, in the embodiment shown in FIG. 22, during a process of the cable end connector 11 engaging the board end connector 12, the cable end major side positioning member lock structure 1123 can enter the board end insulation body major side lock space S1211 to lock the board end major side positioning member lock structure 1221, so as to position the cable end connector 11 by the board end connector 12 to maintain the engaging relationship between the cable end connector 11 and the board end connector 12. Thus, the connector assembly 1 can be used in electronic products with limited internal space, thereby allowing the connector assembly 1 to be used in electronic products with a slim design.

In addition, it should be noted that, during the process of the cable end connector 11 engaging the board end connector 12, the cable end minor side positioning member lock structure 1163 can enter the board end insulation body minor side lock space S1212 to lock the board end minor side positioning member lock structure 1231, so as to position the cable end connector 11 by the board end connector 12 to maintain the engaging relationship between the cable end connector 11 and the board end connector 12. Thus, the connector assembly 1 can be used in electronic products with limited internal space, thereby allowing the connector assembly 1 to be used in electronic products with a slim design.

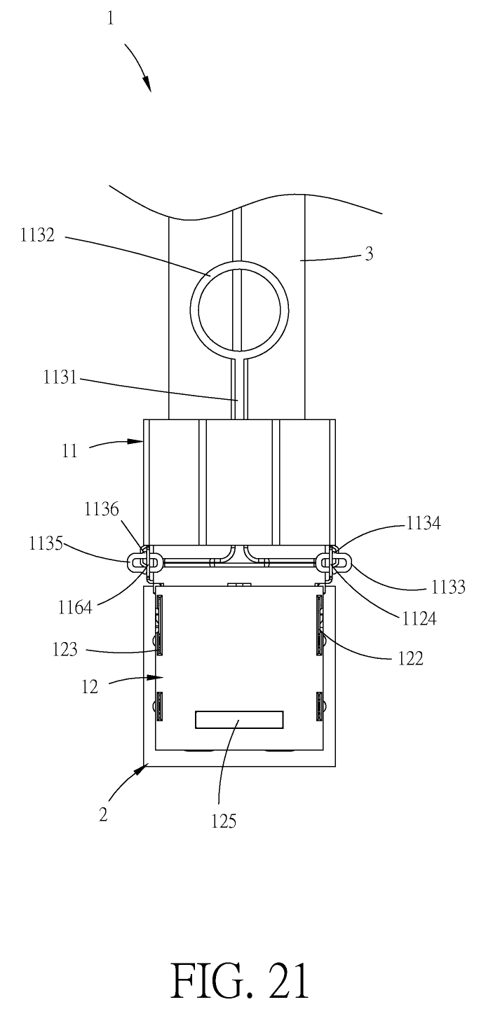

In the embodiment shown in FIG. 21, the cable end pull-tab member force-applying structure 1132 is, for example, an O-ring for providing force application, so that the cable end pull-tab member force-applying structure 1132 can pull the cable end major side positioning member cantilever segment 1122 of the cable end major side positioning member 112, so that the cable end major side positioning member lock structure 1123 can be displaced relative to the board end major side positioning member lock structure 1221 in the board end insulation body major side lock space S1211, thereby releasing a locking of the board end major side positioning member lock structure 1221 by the cable end major side positioning member lock structure 1123.

In addition, the cable end pull-tab member force-applying structure 1132 can further provide force application, so that the cable end pull-tab member force-applying structure 1132 can pull the cable end minor side positioning member cantilever segment 1162 of the cable end minor side positioning member 116, so that the cable end minor side positioning member lock structure 1163 can be displaced relative to the board end minor side positioning member lock structure 1231 in the board end insulation body minor side lock space S1212, thereby releasing a locking of the board end minor side positioning member lock structure 1231 by the cable end minor side positioning member lock structure 1163.

Thus, the cable end pull-tab member force-applying structure 1132 can displace the cable end major side positioning member lock structure 1123 and the cable end minor side positioning member lock structure 1163 in electronic products with limited internal space, allowing the cable end connector 11 to easily release the engaging relationship with the board end connector 12, thereby allowing the connector assembly 1 to be used in electronic products with a slim design.

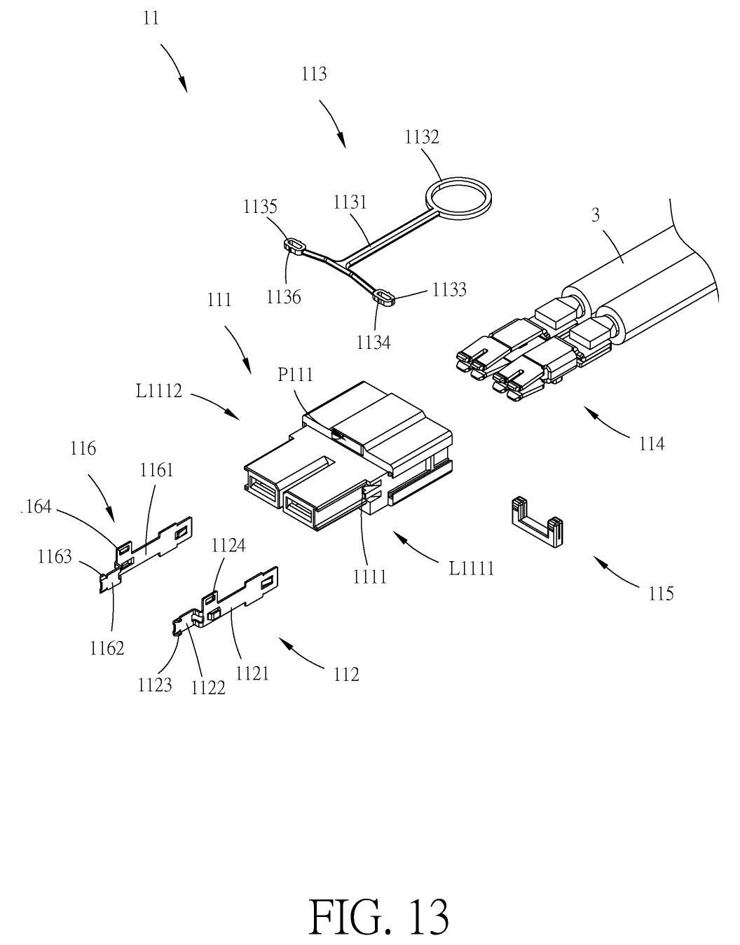

In the embodiments shown in FIGS. 13-15, the cable end insulation body 111 comprises a cable end major side pull limiting structure 1111, and the cable end major side pull limiting structure 1111 is disposed at the cable end body positioning major side L1111. It should be noted that the cable end major side pull limiting structure 1111 is, for example, a stop structure, and during a process of the cable end pull-tab member 113 pulling the cable end major side positioning member cantilever segment 1122, the cable end major side pull limiting structure 1111 can abut against the cable end major side positioning member cantilever segment 1122 to limit a displacement range of the cable end major side positioning member lock structure 1123.

In addition, the cable end insulation body 111 further comprises a cable end minor side pull limiting structure 1112, and the cable end minor side pull limiting structure 1112 is disposed at the cable end body positioning minor side L1112. It should be noted that the cable end minor side pull limiting structure 1112 is, for example, a stop structure, and during a process of the cable end pull-tab member 113 pulling the cable end minor side positioning member cantilever segment 1162, the cable end minor side pull limiting structure 1112 can abut against the cable end minor side positioning member cantilever segment 1162 to limit a displacement range of the cable end minor side positioning member lock structure 1163.

In the embodiment shown in FIG. 15, the cable end connector 11 further comprises: a cable end conductive terminal 114 and a cable end terminal limiting member 115, the cable end conductive terminal 114 enters the cable end insulation body 111, and correspondingly, the cable end terminal limiting member 115 enters the cable end insulation body 111 to be inserted into or abut against the cable end conductive terminal 114, so as to limit the cable end conductive terminal 114 by the cable end insulation body 111.

In addition, the board end connector 12 further comprises: a board end conductive terminal 124 and a board end terminal limiting member 125, the board end conductive terminal 124 enters the board end insulation body 121, and correspondingly, the board end terminal limiting member 125 enters the board end insulation body 121 to be inserted into or abut against the board end conductive terminal 124, so as to limit the board end conductive terminal 124 by the board end insulation body 121.

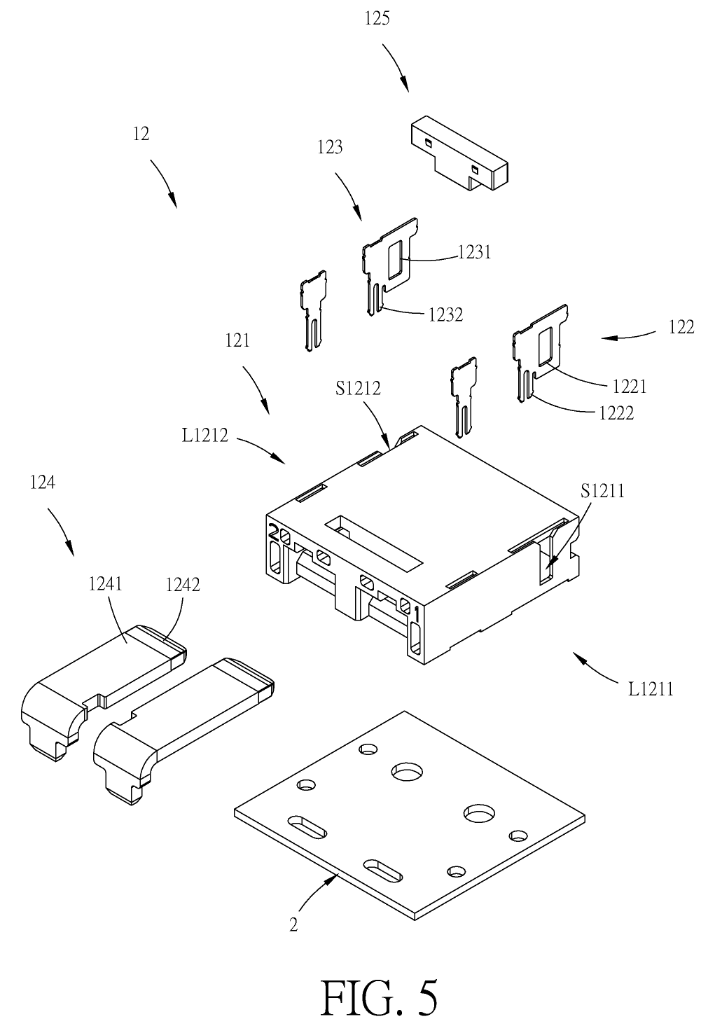

In the embodiment shown in FIG. 5, the board end conductive terminal 124 further comprises a board end terminal front end insulator 1242, and the board end terminal front end insulator 1242 is disposed at a front end of the board end terminal engaging structure 1241. It should be noted that, during the process of the cable end connector 11 engaging the board end connector 12, the cable end conductive terminal 114 can sequentially abut against the board end terminal front end insulator 1242 and the board end terminal engaging structure 1241, and thus, sparks can be prevented from occurring during the engagement of the cable end connector 11 and the board end connector 12.

It should be noted that the connector assembly and the board end connector thereof of the present application can further omit partial members instead of being limited to the above embodiments. For example, the connector assembly of the present application can optionally comprise: a board end connector and a cable end connector. The board end connector comprises: a board end insulation body and a board end major side positioning member; one side of the board end insulation body is a board end body positioning major side, an interior of the board end insulation body comprises a board end insulation body major side lock space, and the board end insulation body major side lock space is disposed at the board end body positioning major side; and the board end major side positioning member comprises a board end major side positioning member lock structure, wherein the board end major side positioning member engages the board end insulation body at the board end body positioning major side, so that the board end major side positioning member lock structure is disposed in the board end insulation body major side lock space. The cable end connector is configured to engage the board end connector, and the cable end connector comprises: a cable end insulation body and a cable end major side positioning member. One side of the cable end insulation body is a cable end body positioning major side. The cable end major side positioning member comprises a cable end major side positioning member lock structure; wherein the cable end major side positioning member engages the cable end insulation body, so that the cable end major side positioning member lock structure is disposed at the cable end body positioning major side; wherein, during a process of the cable end connector engaging the board end connector, the cable end major side positioning member lock structure can enter the board end insulation body major side lock space to lock the board end major side positioning member lock structure, so as to position the cable end connector by the board end connector.

In addition, the board end connector of the present application can optionally comprise: a board end insulation body and a board end major side positioning member. One side of the board end insulation body is a board end body positioning major side, an interior of the board end insulation body comprises a board end insulation body major side lock space, and the board end insulation body major side lock space is disposed at the board end body positioning major side. The board end major side positioning member comprises a board end major side positioning member lock structure and a board end major side positioning member insertion structure, wherein the board end major side positioning member engages the board end insulation body at the board end body positioning major side, so that the board end major side positioning member lock structure is disposed in the board end insulation body major side lock space; and the board end major side positioning member insertion structure is configured for providing insertion of a circuit board at the board end body positioning major side, so as to position the board end connector by the circuit board.

In summary, the present application provides a connector assembly, and the connector assembly can be applied to an electronic product, the connector assembly comprises a board end connector and a cable end connector, wherein the cable end connector is configured to engage the board end connector to provide transmission of electrical signals in the electronic product. The board end connector and the cable end connector respectively comprise structurally corresponding lock structures, and the lock structures are configured for providing locking, so as to allow the connector assembly with a reduced size to effectively maintain the engaging relationship between the cable end connector and the board end connector. Thus, the connector assembly can be used in electronic products with limited internal space, thereby allowing the connector assembly to be used in electronic products with a slim design.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A board end connector configured to mate with a circuit board, the board end connector comprising:
a board end insulation body, wherein one side of the board end insulation body is a board end body positioning major side, an interior of the board end insulation body comprises a board end insulation body major side lock space, the board end insulation body major side lock space is disposed at the board end body positioning major side; and
a board end major side positioning member, the board end major side positioning member comprises a board end major side positioning member lock structure and a board end major side positioning member insertion structure, wherein the board end major side positioning member mates with the board end insulation body at the board end body positioning major side, such that the board end major side positioning member lock structure is disposed in the board end insulation body major side lock space; and the board end major side positioning member insertion structure is configured to provide insertion connection with the circuit board at the board end body positioning major side, so as to position the board end connector by way of the circuit board.

2. The board end connector of claim 1, wherein the board end connector further comprises: a board end conductive terminal and a board end terminal limiting member, the board end conductive terminal enters the board end insulation body, the board end terminal limiting member enters the board end insulation body and plug-connects or abuts the board end conductive terminal, so as to limit the board end conductive terminal by way of the board end insulation body.

3. The board end connector of claim 1, wherein another side of the board end insulation body is a board end body positioning minor side, the interior of the board end insulation body further comprises a board end insulation body minor side lock space, the board end insulation body minor side lock space is disposed at the board end body positioning minor side; and the board end connector further comprises: a board end minor side positioning member, the board end minor side positioning member comprises a board end minor side positioning member lock structure and a board end minor side positioning member insertion structure,wherein the board end minor side positioning member mates with the board end insulation body at the board end body positioning minor side, such that the board end minor side positioning member lock structure is disposed in the board end insulation body minor side lock space; and the board end minor side positioning member insertion structure is configured to provide insertion connection with the circuit board at the board end body positioning minor side, so as to position the board end connector by way of the circuit board.

4. The board end connector of claim 3, wherein the board end major side positioning member lock structure is a hole-shaped structure; and the board end minor side positioning member lock structure is a hole-shaped structure.

5. The board end connector of claim 3, wherein the board end major side positioning member and the board end minor side positioning member are metal members.

6. A connector assembly comprising:
a board end connector comprising:
a board end insulation body, wherein one side of the board end insulation body is a board end body positioning major side, an interior of the board end insulation body comprises a board end insulation body major side lock space, the board end insulation body major side lock space is disposed at the board end body positioning major side;
a board end major side positioning member comprising a board end major side positioning member lock structure, wherein the board end major side positioning member mates with the board end insulation body at the board end body positioning major side, such that the board end major side positioning member lock structure is disposed in the board end insulation body major side lock space;
a cable end connector configured to engage the board end connector, the cable end connector comprises:
a cable end insulation body, wherein one side of the cable end insulation body is a cable end body positioning major side; and
a cable end major side positioning member comprising a cable end major side positioning member lock structure; wherein the cable end major side positioning member mates with the cable end insulation body, such that the cable end major side positioning member lock structure is disposed at the cable end body positioning major side; wherein,
during a process in which the cable end connector engages the board end connector, the cable end major side positioning member lock structure is configured to enter the board end insulation body major side lock space and lock with the board end major side positioning member lock structure, so as to position the cable end connector by way of the board end connector.

7. The connector assembly of claim 6, wherein the cable end connector further comprises: a cable end conductive terminal; and the board end connector further comprises: a board end conductive terminal comprising a board end terminal engaging structure and a board end terminal front end insulator, the board end terminal front end insulator is disposed at a front end of the board end terminal engaging structure, so that during a process in which the cable end connector engages the board end connector, the cable end conductive terminal sequentially abuts the board end terminal front end insulator and the board end terminal engaging structure.

8. The connector assembly of claim 6, wherein another side of the board end insulation body is a board end body positioning minor side, the interior of the board end insulation body further comprises a board end insulation body minor side lock space disposed at the board end body positioning minor side;
the board end connector further comprises: a board end minor side positioning member further comprising a board end minor side positioning member lock structure, wherein the board end minor side positioning member mates with the board end insulation body at the board end body positioning minor side, such that the board end minor side positioning member lock structure is disposed in the board end insulation body minor side lock space;
another side of the cable end insulation body is a cable end body positioning minor side; and the cable end connector further comprises:
a cable end minor side positioning member comprising a cable end minor side positioning member lock structure; wherein the cable end minor side positioning member mates with the cable end insulation body, such that the cable end minor side positioning member lock structure is disposed at the cable end body positioning minor side; wherein
during a process in which the cable end connector engages the board
end connector, the cable end minor side positioning member lock structure is configured to enter the board end insulation body minor side lock space and lock with the board end minor side positioning member lock structure, so as to position the cable end connector by way of the board end connector.
